(19) United States
(12) Patent Application Publication
(10) Pub. No.: US 2025/0124785 A1
(43) Pub. Date: Apr. 17, 2025

(54) TRAFFIC CONTROL APPARATUS, TRAFFIC CONTROL SYSTEM, TRAFFIC CONTROL METHOD, AND STORAGE MEDIUM

(71) Applicant: NEC Corporation, Minato-ku, Tokyo (JP)

(72) Inventor: Kosei Kobayashi, Tokyo (JP)

(73) Assignee: NEC Corporation, Minato-ku, Tokyo (JP)

(21) Appl. No.: 18/834,796

(22) PCT Filed: Mar. 18, 2022
(86) PCT No.: PCT/JP2022/012793

§ 371 Date: Jul. 31, 2024

(51) Int. Cl. G08G 1/08; G08G 1/01; G08G 1/081

(52) U.S. Cl. CPC G08G 1/08; G08G 1/0129; G08G 1/0145; G08G 1/081

(57) ABSTRACT

A traffic control apparatus (102) includes an estimation unit (103) that estimates an emission amount of a vehicle at a target point, and a traffic control unit (104) that executes processing for controlling a traffic volume of a vehicle passing through a target point by use of the estimated emission amount.

### TECHNICAL FIELD

The present invention relates to a traffic control apparatus, a traffic control system, a traffic control method, and a storage medium.

### BACKGROUND ART

Patent Document 1 discloses a technique for estimating a traffic volume. Non-Patent Document 1 discloses a technique for estimating a carbon dioxide emission amount.

### RELATED DOCUMENT

### Patent Document

Patent Document 1: Japanese Patent Application Publication No. 2018-055455

### Non-Patent Document

Non-Patent Document 1: Tetsuhioro ISHIZAKA, et al., “Review and application of CO₂ emission estimation method for automobile traffic”, [online], [Searched on Dec. 20, 2021], Internet <URL: http://library.jsce.or.jp/jsce/open/00039/200906_no39/pdf/35.pdf>

### DISCLOSURE OF THE INVENTION

### Technical Problem

Recently, as a measure against global warming, emission reduction of a greenhouse gas such as CO₂ has been an issue, and an exhaust gas of a vehicle has been pointed out as one of causes of an increase in a greenhouse gas.

Even when a conventional technique can estimate a traffic volume and a carbon dioxide emission amount, no technique for reducing an emission amount has been disclosed.

The present invention has been made in view of the circumstances described above, and one of objects thereof is to reduce an emission amount of a vehicle.

### Solution to Problem

According to one aspect of the present invention, there is provided a traffic control apparatus including:
an estimation unit that estimates an emission amount of a vehicle at a target point; and
a traffic control unit that executes processing for controlling traffic of a target vehicle by use of the estimated emission amount.

According to one aspect of the present invention, there is provided a traffic control method including, by a computer:
estimating an emission amount of a vehicle passing through a target point; and
executing processing for controlling traffic of a target vehicle by use of the estimated emission amount.

According to one aspect of the present invention, there is provided a traffic control system including:
the traffic control apparatus described above;
a piece of sensor equipment that detects a physical amount for estimating an emission amount at the target point; and
at least one of a traffic light and an in-vehicle apparatus.

According to one aspect of the present invention, there is provided a storage medium storing a program for causing a computer to execute:
estimating an emission amount of a vehicle passing through a target point; and
executing processing for controlling traffic of a target vehicle by use of the estimated emission amount.

### Advantageous Effects of Invention

According to the present invention, it becomes possible to reduce an emission amount from a vehicle at a target point.

### BRIEF DESCRIPTION OF THE DRAWINGS

FIG. 1 is a diagram illustrating an example of a configuration of a traffic control system according to a first example embodiment of the present invention.

FIG. 2 is a diagram illustrating an example of a target point, and a piece of sensor equipment and a traffic light associated with each of the target points.

FIG. 3 is a diagram illustrating one example of sensor information.

FIG. 4 is a diagram illustrating an example of a physical configuration of a traffic control system according to the first example embodiment.

FIG. 5 is a diagram illustrating one example of a flowchart of traffic control processing according to the first example embodiment of the present invention.

FIG. 6 is a diagram illustrating an example of a configuration of a traffic control system according to a first modified example.

FIG. 7 is a diagram illustrating an example of configuration of a traffic control system according to a second example embodiment of the present invention.

FIG. 8 is a diagram illustrating one example of a flowchart of traffic control processing according to the second example embodiment of the present invention.

FIG. 9 is a diagram illustrating an example of a functional configuration of a traffic control unit according to a fourth modified example.

FIG. 10 is a diagram illustrating an example of a functional configuration of a traffic control unit according to a fifth modified example.

FIG. 11 is a diagram illustrating an example of a functional configuration of a traffic control apparatus according to the fifth modified example.

### EXAMPLE EMBODIMENT

Hereinafter, example embodiments of the present invention are described by use of the drawings. Note that, a similar reference sign is assigned to a similar component in all the drawings, and description is omitted as appropriate.

### First Example Embodiment

### (Configuration of Traffic Control System 100)

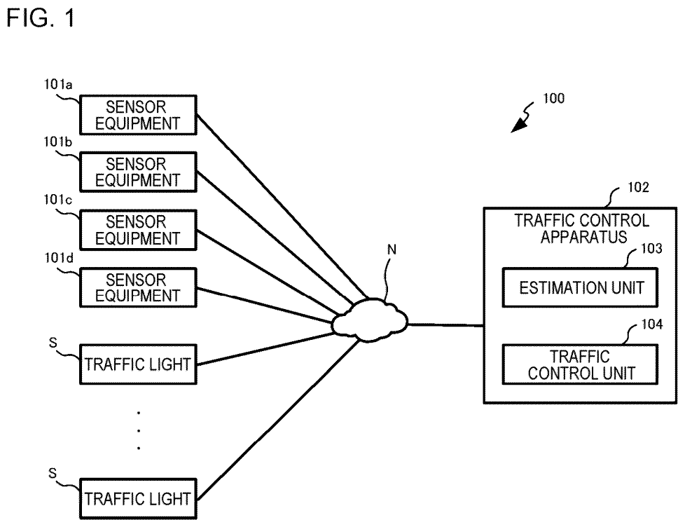

A traffic control system 100 according to a first example embodiment of the present invention is a system for controlling traffic of a vehicle C on roads R1 to R4. As illustrated in FIG. 1, the traffic control system 100 includes pieces of sensor equipment 101a to 101d, a traffic control apparatus 102, and a plurality of traffic lights S.

The traffic control apparatus 102, pieces of the sensor equipment 101a to 101d, and each of the traffic lights S are interconnected in a wired or wireless way, or via a network N constructed by combining the wired and wireless ways. Thereby, the traffic control apparatus 102 and each piece of the sensor equipment 101a to 101d can transmit and receive information to and from each other. Moreover, the traffic control apparatus 102 and each of the traffic lights S can transmit and receive information to and from each other.

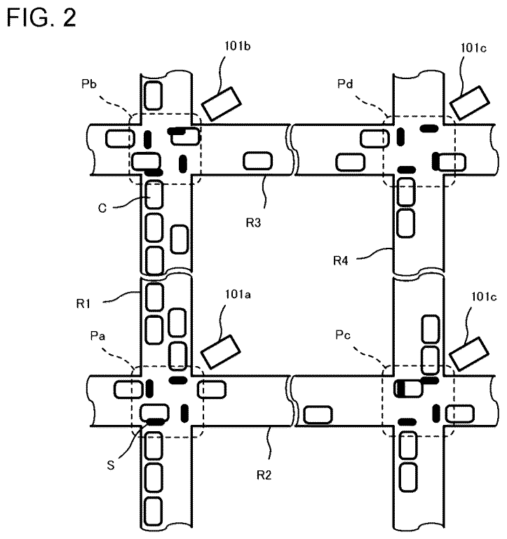

As illustrated in FIG. 2, pieces of the sensor equipment 101a to 101d are installed in association with target points Pa to Pd that are intersections of roads R1 to R4, respectively. FIG. 2 is a diagram in which the roads R1 to R4 are viewed from above, and is a diagram illustrating an example of the target points Pa to Pd, and pieces of the sensor equipment 101a to 101d and the traffic light S associated with the target points Pa to Pd, respectively. Each of roads R1 to R4 is an example of a road with two lanes for left-hand traffic (i.e., one lane in each of upward and downward directions in FIG. 2 on the roads R1 and R4, and one lane in each of leftward and rightward directions in FIG. 2 on the roads R2 and R3).

Note that, a target point is not limited to an intersection, and may be any point previously determined in relation to the roads R1 to R4 in a predetermined section or the like of the roads R1 to R4.

Each piece of the sensor equipment 101a to 101d includes a sensor that detects a physical amount for estimating an emission amount at each of the associated target points Pa to Pd. Each piece of the sensor equipment 101a to 101d generates sensor information including a physical amount detected by the sensor, and transmits the sensor information to the traffic control apparatus 102 via the network N.

Each piece of the sensor equipment 101a to 101d according to the present example embodiment generates sensor information including an image capturing each of the associated target points Pa to Pd, and transmits the sensor information to the traffic control apparatus 102. Each piece of the sensor equipment 101a to 101d is composed of, for example, a camera including an image sensor that detects a color and brightness according to light from an imaging region as a physical amount for each pixel, and the like.

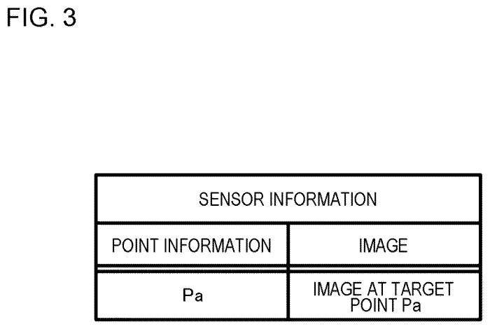

The sensor information includes point information and an image, as one example is illustrated in FIG. 3.

The point information is information for identifying the target points Pa to Pd. The sensor information illustrated in FIG. 2 is an example of sensor information generated by the sensor equipment 101a, and includes point information “Pa” indicating the target point Pa and an image of the target point Pa.

Hereinafter, the roads R1 to R4 are also simply referred to as a “road R” when not particularly distinguished. The target points Pa to Pd are also simply referred to as “target point P” when not particularly distinguished. The pieces of sensor equipment 101a to 101d are also simply referred to as “sensor equipment 101” when not particularly distinguished.

Note that, the number of the target points P is not limited to four, but may be one or more. The number of the pieces of sensor equipment 101 is not limited to four, and one or more pieces of the sensor equipment 101 may be installed in association with each of one or a plurality of target points. The number of the traffic lights S may also be one or more.

### (Functional Configuration of Traffic Control Apparatus 102)

The traffic control apparatus 102 functionally includes an estimation unit 103 and a traffic control unit 104, as illustrated in FIG. 1.

The estimation unit 103 acquires sensor information from the sensor equipment 101 via the network N. Then, the estimation unit 103 estimates an emission amount of the vehicle C at the target point P, based on the acquired sensor information.

An emission amount of the vehicle C according to the present example embodiment is an amount of carbon dioxide (CO₂) emitted from the vehicle C, i.e., a CO₂ amount.

Note that, an emission amount of the vehicle C is not limited to a CO₂ amount emitted from the vehicle C, and, for example, may be a total amount of a gas emitted from the vehicle C, or may be an amount of a gas of a specific component emitted from the vehicle C. A greenhouse gas is suitable as a gas of a specific component, and CO₂ is one example of a greenhouse gas. Moreover, as a greenhouse gas other than CO₂, methane, dinitrogen monoxide, and the like can be cited.

The traffic control unit 104 executes processing for controlling traffic of the target vehicle C, by use of the emission amount estimated by the estimation unit 103. The target vehicle C may be a vehicle whose emission amount is estimated by the estimation unit 103, or may be a vehicle other than the vehicle whose emission amount is estimated by the estimation unit 103.

The traffic control unit 104 according to the present example embodiment controls the plurality of traffic lights S by use of the estimated emission amount estimated by the estimation unit 103. Thereby, the traffic control unit 104 according to the present example embodiment controls traffic of the target vehicle C. That is to say, in the present example embodiment, a target vehicle is a vehicle C passing through the target point P where the traffic light S to be a control target is installed. Note that, the number of the traffic lights S to be a target for control may be one.

For example, the traffic control unit 104 controls the traffic light S by use of the emission amount estimated by the estimation unit 103, in such a way that a velocity change amount of the target vehicle becomes small.

Moreover, for example, the traffic control unit 104 determines, by use of the emission amount estimated by the estimation unit 103, whether the estimated emission amount exceeds a previously determined criterion value for each of the target points P. Then, when the target point P exceeding a previously determined criterion value is present, the traffic control unit 104 controls the traffic light S in such a way as to decrease a traffic volume of the vehicle C at the target point P exceeding the criterion value.

Further, for example, the traffic control unit 104 controls traffic of a target vehicle by use of the emission amount estimated by the estimation unit 103 in such a way as to pass through the target point P where the estimated emission amount is smaller than that at the another target point P.

Further, for example, regarding each of the target points P, the traffic control unit 104 determines, by use of the emission amount estimated by the estimation unit 103, whether the estimated emission amount is smaller than a previously determined criterion value. Then, when the target point P being smaller than a previously determined criterion value is present, the traffic control unit 104 controls traffic of a target vehicle in such a way as to pass through the target point P being smaller than the criterion value with priority over the another target point where the estimated emission amount is larger than that at the former target point P.

### (Physical Configuration of Traffic Control Apparatus 102)

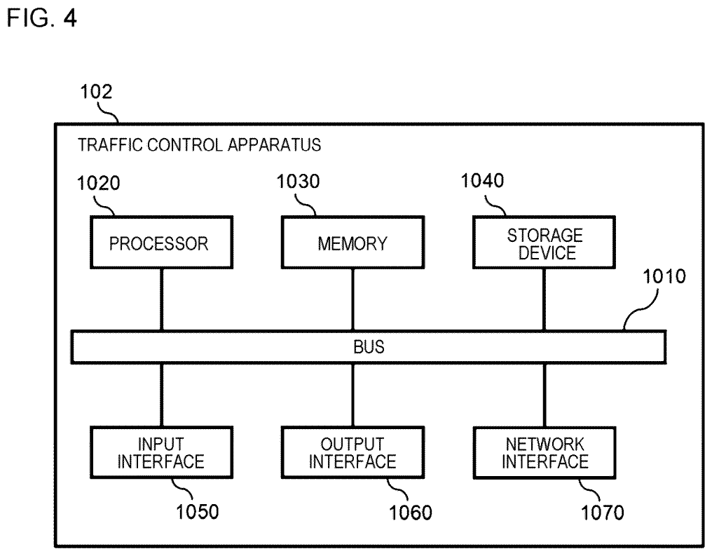

The traffic control apparatus 102 is physically, for example, a general-purpose computer, and, as illustrated in FIG. 4 includes a bus 1010, a processor 1020, a memory 1030, a storage device 1040, an input interface 1050, an output interface 1060, and a network interface 1070.

The bus 1010 is a data transmission path through which the processor 1020, the memory 1030, the storage device 1040, the input interface 1050, the output interface 1060, and the network interface 1070 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function of the traffic control apparatus 102. The processor 1020 reads each of the program modules onto the memory 1030, executes the read program module, and thereby achieves each function associated with the program module.

The input interface 1050 is an interface for a user to input information, and is, for example, one or a plurality of a touch panel, a keyboard, a mouse, and the like.

The output interface 1060 is an interface for presenting information to the user, and is, for example, one or a plurality of a liquid crystal panel, an organic electro luminescence (EL) panel, and the like.

The network interface 1070 is an interface for connecting the traffic control apparatus 102 to the network N.

So far, a configuration of the traffic control system 100 according to the first example embodiment of the present invention has been described. From here, an operation of the traffic control system 100 according to the present example embodiment is described.

### (Operation of Traffic Control System 100)

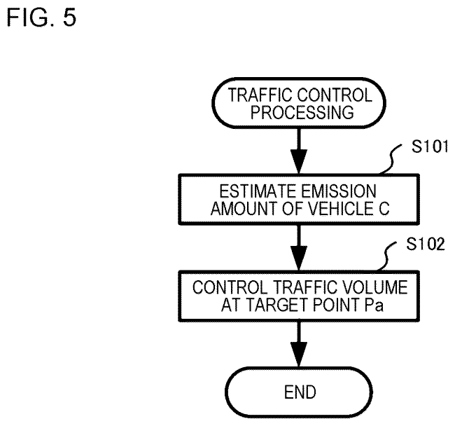

The traffic control processing according to the present example embodiment is a method for the traffic control apparatus 102 to control, based on sensor information, traffic of a target vehicle on the roads R1 to R4, and one example of a flowchart thereof is illustrated in FIG. 5. The traffic control processing is repeatedly executed in real time, for example, when the traffic control apparatus 102 acquires sensor information from each piece of the sensor equipment 101.

### (Regarding Step S101)

The estimation unit 103 estimates an emission amount of the vehicle C at the target point P, based on the sensor information acquired from the sensor equipment 101 (step S101).

Specifically, for example, an image at each of the target points Pa to Pd is determined based on point information included in the sensor information, and an emission of vehicle C at the target point P is estimated based on the image at each of the target points Pa to Pd.

Note that, the sensor information may include, instead of the point information, a sensor identifier (ID) for identifying pieces of the sensor equipment 101a to 101d, addresses of pieces of the sensor equipment 101a to 101d in the network N, and the like. In this case, the estimation unit 103 previously retains data for conversion that associates a sensor ID or an address with point information, and relates an image of the sensor information with the target points Pa to Pd by referring to the data for conversion.

### (Estimation Method for Emission Amount)

A conventional method may be adopted as a method of estimating an emission amount from an image, and, for example, an emission amount of the vehicle C at the target point P is estimated by use of a previously prepared emission estimation model.

The emission estimation model is a model that outputs an estimate value of an emission amount of the vehicle C at the target point P, with, as input data, data (image data) including an image at each of the target points Pa to Pd.

Although a previously determined standard emission estimation model for the vehicle C may be adopted as the emission estimation model, the present example embodiment is described with an example in which an emission estimation model for each vehicle type is used. That is to say, in the present example embodiment, the emission estimation model estimates an emission amount of the vehicle C at each of the target points Pa to Pd, with an image of each of the target points Pa to Pd as input data.

Herein, the vehicle type is a kind of a vehicle, and is preferably a kind relating to the environmental performance of the vehicle. A kind relating to environmental performance of a vehicle is, for example, a vehicle kind, a kind of a power generation source of the vehicle, or the like. As a kind of a power generation source of a vehicle, there are, for example, an electric vehicle with electricity as a power generation source, and a fuel-using vehicle that uses fuel as a power generation source. The fuel-using vehicle may be further classified into an engine (internal combustion engine) vehicle with only fuel as a power generation source, a hybrid car with both fuel and electricity as power generation sources, and the like. The engine vehicle may be further classified into a gasoline vehicle, a diesel vehicle, and the like, according to a kind of fuel used to be a power generation source.

Specifically, for example, the emission estimation model includes a first model and a second model.

The first model is a model for deriving, with an image at each of the target points Pa to Pd as input data, traffic information for the vehicle C at each of the target points Pa to Pd. The traffic information includes a vehicle type of each of the vehicles C, and may further include the number of vehicles for each vehicle type.

For the first model, a learned learning model for which machine learning for outputting, with image data at the target point P as input data, traffic information for the vehicle C at the target point P is preferred. In the machine learning of the first model, for example, data including a vehicle type of the vehicle C included in the image of the input data and the number of vehicles for each vehicle type are used as training data.

The second model is a model that outputs, with traffic information for the vehicle C at the target point P acquired in the first model as input data, an estimate value of an emission amount of each of the vehicles C at the target point P, and a sum thereof. An example of the second model is described below.

### Example 1 of Second Model

A first example of the second model is a model that includes a constant emission amount per vehicle that is previously determined for each vehicle type (e.g., an average emission amount during traveling for each vehicle type).

The estimation unit 103 determines a second model according to a vehicle type of each of the vehicles C at the target point P acquired by the first model, and designates an emission amount included in the second model as an estimate value of an emission amount of each of the vehicles C. Then, the estimation unit 103 computes a sum of an estimate value of an emission amount of each of the vehicles C, and thereby derives a sum of the estimate value of the emission amount of the vehicle C at the target point P.

### Example 2 of Second Model

A second example of the second model is a model that estimates an emission amount per vehicle for each vehicle type, in consideration of one or a plurality of traveling conditions. Such a second model may be represented by a previously determined function including a traveling condition in a parameter, a table that defines a value according to a combination of traveling conditions, and the like, and may be a learned learning model for which machine learning for estimating an emission amount of the vehicle C at the target point P has been performed.

The traveling condition is a condition related to traveling of the vehicle C, and particularly affects an emission amount of the vehicle C. As the traveling condition, a traveling velocity of the vehicle C, a change rate in the traveling velocity of the vehicle C, an idling stop state during stoppage, a loading amount being a total weight of a person on board the vehicle C and luggage loaded on the vehicle C, road information, weather information, a road surface state of a road, and a vehicle state can be exemplified.

The traveling velocity of the vehicle C, the change rate in the traveling velocity of the vehicle C, the idling stop state during stoppage, the loading amount being the total weight of the person on board the vehicle C and the luggage loaded on the vehicle C are estimated based on an image at the target point P.

The traveling velocity and the change rate thereof are estimated, for example, by deriving a movement amount of the vehicle C per time through image processing. The idling stop state during stoppage is estimated based on, for example, a vehicle kind estimated from an image of the stopped vehicle C, and vehicle kind data relating vehicle kind information indicating a vehicle kind with idling stop information indicating whether an idling stop function is installed. The loading amount is estimated, for example, based on information from a weight sensor mounted on the vehicle C and a sinking amount derived by image processing.

Road information is, for example, information indicating an attribute of the road R on which the vehicle C travels, and is information indicating, for example, a slope, a curve, the number of lanes, a lane in which the vehicle has traveled, and installation status of a CO₂ absorber in a building or the like around a road.

The weather information is, for example, information indicating wind power acquired from a wind meter installed on a road, an external apparatus (not illustrated) that provides weather information, or the like.

The road surface state of the road R is, for example, presence or absence of snow on a road surface, whether a road surface is wet due to rain or the like, and whether a road surface is frozen. The vehicle state is, for example, presence or absence of a chain attached to a tire of the vehicle C. Each of the road surface state and the vehicle state may be estimated by use of, for example, a learned learning model for which machine learning for estimating a road surface state or a vehicle state has been performed, with an image included in sensor information as input data. The learning model outputs a road surface state or a vehicle state. In machine learning, for example, a road surface state of the road R or a vehicle state of the vehicle C included in an image of input data is used as training data.

The estimation unit 103 determines a second model according to a vehicle type of each of the vehicles C at the target point P acquired with the first model. The estimation unit 103 inputs a traveling condition of each of the vehicles C to a second model being relevant to the vehicle type of each of the vehicles C at the target point P, and thereby estimates an estimate value of an emission amount of each of the vehicles C at the target point P. Then, the estimation unit 103 computes a sum of an estimate value of an emission amount of each of the vehicles C, and thereby derives a sum of an estimate value of an emission amount of the vehicle C at the target point P.

When the second model is a learned learning model for which machine learning has been performed, for example, a learning model for which machine learning for estimating an emission amount of the vehicle C has been performed, with a traveling condition of the vehicle C as input data is adopted as the second model.

In the machine learning in this case, for example, data indicating an emission amount for each vehicle type are used as training data. An emission amount for each vehicle type may be acquired experimentally based on a sensor (e.g., a flow rate sensor, a CO₂ sensor) installed on a vehicle, and may be a value produced by referring to a value contained in a catalog of the vehicle, or the like.

By adopting an emission estimation model that takes such a traveling condition into consideration, a CO₂ emission amount on a road can be estimated in consideration of the traveling condition of the vehicle C. Thus, it becomes possible to more accurately estimate an emission amount of the vehicle C at the road target point P.

### (Regarding Step S102)

The traffic control unit 104 executes processing for controlling a traffic volume of the target vehicle by use of the emission amount estimated in step S101 (step S102), and ends the traffic control processing.

Specifically, for example, the traffic control unit 104 determines whether a sum of an estimate value of an emission amount at each of the target points P exceeds a previously determined criterion value. When it is determined that the criterion value has been exceeded, the traffic control unit 104 generates control information for controlling the traffic light S installed at each of the target points P, and transmits the generated control information to the corresponding traffic light S or a control apparatus (not illustrated) of the traffic light S.

The control information is, for example, information for determining a time of switching the traffic light S between green and red, and includes a time length of each of green light and red light, and the like.

As a first example of a control method of the traffic light S, as described above, traffic of a target vehicle may be controlled in such a way that a velocity change amount of the vehicle C passing through the target point P becomes small.

For example, referring to FIG. 2, a traffic amount of the vehicle C going upward on the road R1 is large, and a traffic jam is occurring between the target point Pa and the target point Pb. Thus, at the target point Pa, the vehicle C going upward on the road R1 repeatedly starts, slows down, and stops, a velocity change amount thereby becomes large, and, as a result, an emission amount often becomes large. In such a situation, a sum of the estimate value of the emission amount at the target point Pa exceeds the previously determined criterion value. On the other hand, in the example illustrated in FIG. 2, a traffic volume on each of the roads R2 and R3 is smaller than a traffic volume of the vehicle C going upward on the road R1.

In such a case, the traffic control unit 104 controls the traffic light S on the road R1 in such a way that a time of being green is longer than a time of being red at the target point Pa, and controls the traffic light S on the road R2 in such a way that a time of being green is shorter than a time of being red. Moreover, at the target point Pb, the traffic control unit 104 controls the traffic light S on the road R1 in such a way that a time of being green is longer than a time of being red, and controls the traffic light S on the road R3 in such a way that a time of being green is shorter than a time of being red.

Further, the traffic control unit 104 may control in such a way that a time period in which the traffic light S on the road R1 is green is synchronized at the target point Pa and the target point Pb.

Thereby, a velocity change amount of the vehicle C passing through the target point Pa via the road R1 can be caused to be small. Therefore, it becomes possible to reduce an emission amount from the vehicle C at the target point Pa.

As a second example of a control method of the traffic light S, as described above, traffic of a target vehicle may be controlled in such a way as to decrease a traffic volume of the vehicle C at the target point P.

For example, as described in the first example of the control method of the traffic light S, it is assumed that a sum of an estimate value of an emission amount at the target point Pa exceeds a previously determined criterion value. In this case, for example, the traffic light S (not illustrated) at an intersection below the target point Pa is controlled in such a way that a time of being green of the traffic light S going toward the target point Pa through the road R1 becomes shorter than a time of being red, and controlled in such a way that a time of being green of the another traffic light S becomes longer than a time of being red.

Thereby, a traffic volume of the vehicle C at the target point Pa can be decreased by guiding the vehicle C in such a way as to detour to the road R where a time of being green is long. Therefore, it becomes possible to reduce an emission amount from the vehicle C at the target point Pa.

As a third example of a control method for the traffic light S, as described above, traffic of a target vehicle may be controlled in such a way as to pass through, with priority, the target point P where an estimated emission amount is smaller than that at the another target points P.

For example, as described in the first example of the control method of the traffic light S, it is assumed that a sum of an estimate value of an emission amount at the target point Pa is larger than those at the other target points Pb, Pc, and Pd. In this case, for example, the traffic light S (not illustrated) at an intersection below the target point Pa is controlled in such a way that a time of being green of the traffic light S going toward the target point Pa through the road R1 becomes shorter than a time of being red, and controlled in such a way that a time of being green of the another traffic light S becomes longer than a time of being red.

Thereby, traffic of a target vehicle can be controlled in such a way as to pass through, with priority, for example, the target point Pb where a sum of an estimate value of an emission amount is smaller than that at the target point Pa, by guiding the vehicle C in such a way as to detour to the road R where a time of being green is long. Therefore, it becomes possible to reduce an emission amount from the vehicle C at the target point Pa.

As a fourth example of a control method for the traffic light S, as described above, traffic of a target vehicle may be controlled in such a way as to pass through the target point P being smaller than a previously determined criterion value with priority over the another target point P.

For example, it is assumed that a sum of an estimate value of emission amounts at the target points Pa, Pb, and Pc is larger than at the target point Pd. Moreover, it is assumed that at the target point Pd, a sum of an estimate value of an emission amount is smaller than a criterion value.

In this case, for example, the traffic light S (not illustrated) at an intersection located to right of or below the target point Pd is controlled in such a way that a time of being green of the traffic light S going toward the target points Pb and Pc through a non-illustrated road is shorter than a time of being red, and controlled in such a way that a time of being green of the another traffic light S is longer than a time of being red.

Thereby, traffic of a target vehicle can be controlled, for example, in such a way as to pass through the target point Pd where a sum of an estimate value of an emission amount is smaller than criterion value, with priority over the other target points Pa, Pb, and Pc, by guiding the vehicle C in such a way as to detour to the road R where a time of being green is long. Therefore, it becomes possible to reduce an emission amount from the vehicle C at the target point Pa.

The first example embodiment of the present invention has been described so far.

According to the first example embodiment, an emission amount of the vehicle C passing through the target point P is estimated, the traffic light S installed at the target point P is controlled by use of the estimated emission amount, and, thereby, a traffic volume of a vehicle passing through the target point P is controlled. Thereby, it becomes possible to reduce an emission amount from the vehicle C at the target point P.

The present invention is not limited to the first example embodiment, and the first example embodiment may be modified, for example, as follows.

### First Modified Example

In the first example embodiment, an example has been described in which traffic control processing is repeatedly executed in real time when a traffic control apparatus 102 acquires sensor information from each piece of sensor equipment 101. However, sensor information may be stored in a storage unit, and the traffic control processing may be performed at a predetermined time (e.g., every day at a previously determined time, every week on a previously determined day of a week, or every month on a previously determined day).

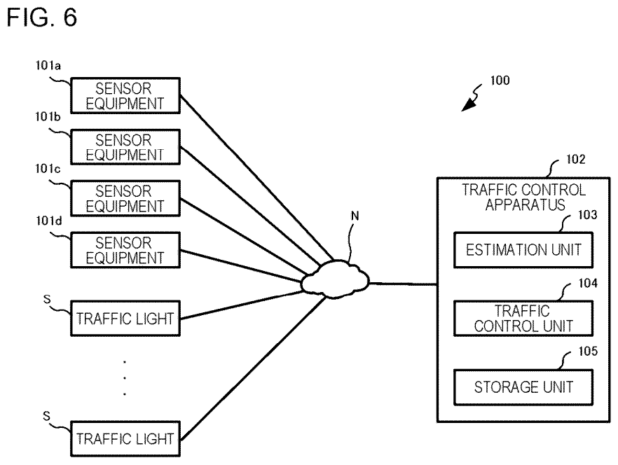

As illustrated in FIG. 6, the traffic control apparatus 102 according to a first modified example further includes a storage unit 105 in addition to a configuration of the traffic control apparatus 102 according to the first example embodiment. When acquiring sensor information from each piece of the sensor equipment 101, an estimation unit 103 stores the acquired sensor information in the storage unit 105. Then, the estimation unit 103 estimates an emission amount of a vehicle C at a target point P, based on the sensor information stored in the storage unit.

In traffic control processing according to the first modified example, in step S101, the estimation unit 103 estimates an emission amount of the vehicle C at the target point P based on the sensor information acquired from the storage unit 105.

According to the present modified example, a pattern of a period when an emission amount of the vehicle C at the target point P becomes large can be estimated based on past sensor information. Thereby, it becomes possible to reduce an emission amount from the vehicle C at the target point P by executing processing for controlling a traffic volume of a target vehicle at a period when an emission amount at the target point P often becomes large.

### Second Modified Example

A piece of sensor equipment 101 according to the first example embodiment is not limited to a camera or the like, and may be, for example, a sensor that detects an emission amount of a vehicle C. An emission amount detected by the sensor is, for example, a concentration of gas (e.g., a greenhouse gas such as carbon dioxide (CO₂)) of a specific component. In this case, the sensor equipment 101 may generate sensor information including the detected concentration of the gas of the specific component, and transmit the sensor information to a traffic control apparatus 102.

The present modified example also provides an effect similar to that according to the first example embodiment.

### Third Modified Example

A traffic control unit 104 may control, by use of an emission amount estimated by an estimation unit 103, a traffic light S according to a proportion of a vehicle type of a vehicle C passing through each of target points P.

For example, when an estimate value of an emission amount at a target point Pa being an intersection exceeds a criterion value, a traffic control unit 104 controls a traffic light S of roads R1 and R2 that intersect at the target point Pa, according to whether a proportion of an electric vehicle and a hybrid car on the roads R1 and R2 that intersect at the target point Pa is large or small.

Specifically, for example, it is assumed that a proportion of an electric vehicle and a hybrid car is larger on the road R1 than on the road R2. In this case, the traffic control unit 104 causes a time of a green light to be shorter at the traffic light S on the road R1 than at the traffic light S on the road R2, and causes a time of a red light to be longer at the traffic light S on the road R1 than at the traffic light S on the road R2.

In general, an electric vehicle and a hybrid car have a smaller emission amount than a fuel vehicle. Thus, according to the present modified example as well, it becomes possible to reduce an emission amount from the vehicle C at a target point P.

### Second Example Embodiment

In the first example embodiment, an example has been described in which, by controlling a traffic light S, a traffic volume of a target vehicle is controlled, with, as a target vehicle, a vehicle C passing through a target point P where the traffic light S is installed. However, a method of controlling traffic of a target vehicle is not limited to thereto. For example, with, as a target vehicle, the vehicle C traveling by use of route guidance provided by a guidance apparatus such as an in-vehicle apparatus or a terminal apparatus, a traffic volume of a target vehicle may be controlled by providing the route guidance to the target vehicle through the guidance apparatus.

The route guidance of the guidance apparatus is a function of informing a driver of a route from a departure point to a destination by use of a map, voice, and the like. Each of the departure point and the destination is specified by, for example, a user of the guidance apparatus.

In a second example embodiment, an example is described with a case where an in-vehicle apparatus mounted on a target vehicle performs route guidance to a destination, and, thereby, traffic of a target vehicle is controlled. In the present example embodiment, a point different from the first example embodiment is mainly described, and duplicate description is omitted as appropriate in order to simplify description.

### (Configuration of Traffic Control System 200)

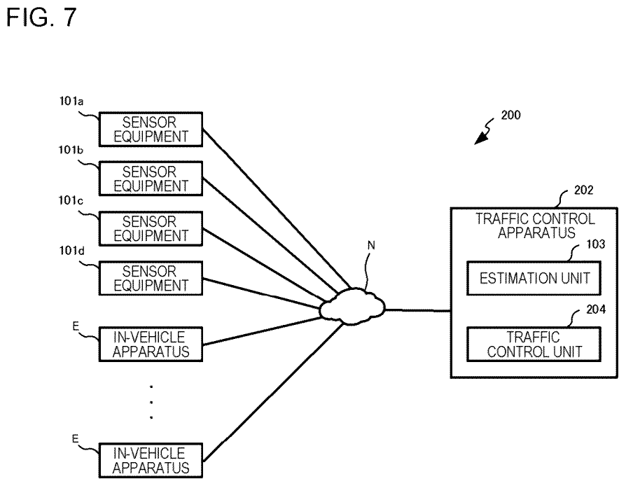

As illustrated in FIG. 7, a traffic control system 200 according to the second example embodiment of the present invention includes pieces of sensor equipment 101a to 101d similar to those according to the first example embodiment, and a traffic control apparatus 202 and an in-vehicle apparatus E that replace the traffic light S and a traffic control apparatus 102 according to the first example embodiment.

The in-vehicle apparatus E is an apparatus mounted on a vehicle C being a target vehicle, and is, for example, a car navigation apparatus. The in-vehicle apparatus E is interconnected with the traffic control apparatus 202 via a network N. Thereby, the traffic control apparatus 202 and the in-vehicle apparatus E can transmit and receive information to and from each other.

The in-vehicle apparatus E transmits vehicle information of the target vehicle to the traffic control apparatus 202. The vehicle information includes, for example, a vehicle number, a vehicle kind, an address for communication, a destination, and a departure point.

The in-vehicle apparatus E acquires, via the network N, route information transmitted to the address included in the vehicle information. The route information is information including a route to the destination. The in-vehicle apparatus E guides the vehicle C by voice, display of a road to travel, voice, or the like, according to the acquired route information.

### (Functional Configuration of Traffic Control Apparatus 202)

As illustrated in FIG. 7, the traffic control apparatus 202 functionally includes an estimation unit 103 similar to that according to the first example embodiment, and a traffic control unit 204 that replaces a traffic control unit 104 according to the first example embodiment.

The traffic control unit 204 executes processing for controlling traffic of a target vehicle, by use of an emission amount estimated by the estimation unit 103. The traffic control unit 204 according to the present example embodiment controls traffic of the target vehicle by performing route guidance for the target vehicle by use of an emission amount estimated by the estimation unit 103.

Specifically, for example, when the traffic control unit 204 acquires vehicle information from the in-vehicle apparatus E of the target vehicle, the traffic control unit 204 determines the route to the destination of the target vehicle by use of vehicle information and an emission amount estimated by the estimation unit 103, and generates route information including the determined route. The traffic control unit 204 transmits the generated route information to an address included in the vehicle information acquired from the target vehicle.

Note that, when the vehicle C being the target vehicle is automatically driven, the target vehicle may travel according to the route information.

### (Physical Configuration of Traffic Control Apparatus 202)

The traffic control apparatus 202 may be physically configured similarly to the traffic control apparatus 102 according to the first example embodiment.

### (Operation of Traffic Control System 200)

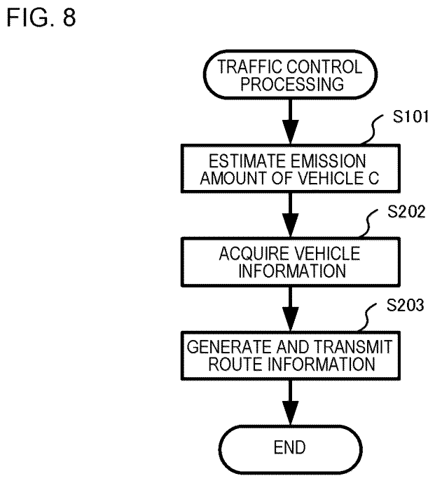

The traffic control processing according to the present example embodiment is a method for the traffic control apparatus 202 to control, based on sensor information, traffic of a target vehicle on roads R1 to R4, and one example of a flowchart thereof is illustrated in FIG. 8. The traffic control processing is repeatedly executed in real time, for example, when the traffic control apparatus 202 acquires sensor information from each piece of the sensor equipment 101.

The estimation unit 103 executes step S101 similar to that according to the first example embodiment.

The traffic control unit 204 acquires vehicle information of the target vehicle from the in-vehicle apparatus E of the target vehicle via the network N (step S202).

The traffic control unit 204 generates route information including a route to a destination of the target vehicle by use of an emission amount estimated in step S101 and vehicle information acquired in step S202, and transmits the route information to the in-vehicle apparatus E of the target vehicle (step S203). In this way, the traffic control unit 204 executes processing of controlling traffic of the target vehicle, and ends the traffic control processing.

Specifically, for example, the traffic control unit 204 may determine a route to a destination of the target vehicle by use of an estimated emission amount and vehicle information in such a way as to pass through, with priority, the target point P where the estimated emission amount is smaller than that at the another target point P.

Specifically, for example, the traffic control unit 204 derives a plurality of candidates of routes to a destination, by use of vehicle information. The traffic control unit 204 determines, by use of the estimated emission amount, a route with a smallest sum of an emission amount estimated regarding the target point P to be passed through, among the plurality of candidates. The traffic control unit 204 generates route information including the determined route, and transmits the route information to the in-vehicle apparatus E. Thereby, the target vehicle can be guided in such a way as to pass through, with priority, the target point P where the estimated emission amount is smaller than that at the another target point P.

Moreover, for example, the traffic control unit 204 may control, by use of the estimated emission amount and vehicle information, traffic of the target vehicle in such a way that a velocity change amount of the target vehicle becomes smaller.

Further, for example, when the target point P exceeding a previously determined criterion value is present, the traffic control unit 204 may control traffic of the target vehicle by use of the estimated emission amount and vehicle information in such a way as to decrease a traffic volume of the vehicle C at the target point P exceeding the criterion value.

Specifically, for example, the traffic control unit 204 derives a plurality of candidates of routes to the destination by use of vehicle information. The traffic control unit 204 determines, by use of the estimated emission amount, a route passing through the target point P that does not exceed the criterion value, among the plurality of candidates. The traffic control unit 204 generates route information including the determined route, and transmits the route information to the in-vehicle apparatus E. Thereby, the target vehicle can be guided in such a way as to decrease a traffic volume of the vehicle C at the target point P exceeding the criterion value.

Further, for example, when the target point P being smaller than a previously determined criterion value is present, the traffic control unit 204 may control traffic of the target vehicle by use of the estimated emission amount and vehicle information, in such a way as to pass through the target point P with priority over another target point.

Specifically, for example, the traffic control unit 204 derives a plurality of candidates of routes to a destination by use of vehicle information. The traffic control unit 204 determines, by use of the estimated emission amount, a route passing through the target point P being smaller than the criterion value, among the plurality of candidates. The traffic control unit 204 generates route information including the determined route, and transmits the route information to the in-vehicle apparatus E. Thereby, the target vehicle can be guided in such a way as to pass through the target point P being smaller than the criterion value with priority over another target point.

So far, the second example embodiment of the present invention has been described.

According to the second example embodiment, traffic of a target vehicle is controlled by estimating an emission amount of the vehicle C passing through the target point P, and performing route guidance for the target vehicle by use of the estimated emission amount. Thereby, it becomes possible to reduce an emission amount from the vehicle C at the target point P.

The present invention is not limited to the example embodiment and the modified examples described so far, and the second example embodiment may be modified, for example, as follows.

### Fourth Modified Example

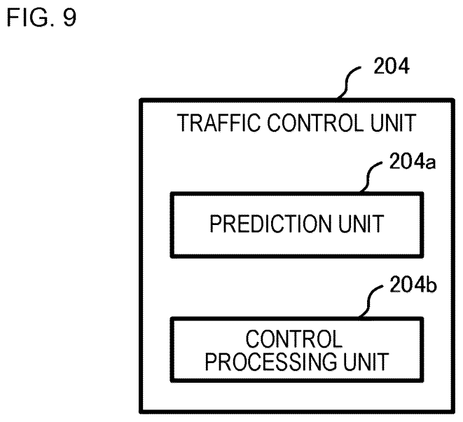

A traffic control unit 204 may predict an emission amount from a vehicle C, and control traffic of a target vehicle by use of an estimated emission amount and a prediction amount. The traffic control unit 204 according to a fourth modified example includes a prediction unit 204a and a control processing unit 204b, as illustrated in FIG. 9.

The prediction unit 204a derives a prediction amount of an emission amount from the vehicle C. A conventional method may be used for the prediction, and, for example, an average value for a previously determined period, an average value for each time period in a previously determined period, a value of a straight line or a curve approximating a change from a previously determined time point to present, or the like may be adopted.

The control processing unit 204b performs route guidance for the target vehicle by use of the emission amount estimated by an estimation unit 103 and the prediction amount derived by the prediction unit 204a. That is to say, a route to a destination of the target vehicle is determined by use of the estimated emission amount and the prediction amount, and route information including the route is generated and transmitted to an in-vehicle apparatus E of the target vehicle.

By predicting an emission amount and performing route guidance for the target vehicle, a possibility that the target vehicle passes through a target point P where an increase in an emission amount is expected can be decreased. Moreover, a traffic volume at the target point P where an increase in an emission amount is expected decreases, whereby a velocity change amount of the vehicle C passing through the target point P becomes smaller, and an emission amount from the vehicle C passing through the target point P can also be decreased. Thus, an increase in an emission amount from the vehicle C at the target point P where an increase in an emission amount is expected can be previously prevented. Therefore, it becomes possible to reduce an emission amount from the vehicle C at the target point P.

Note that, the control processing unit 204b may control the traffic light S by use of the emission amount estimated by the estimation unit 103 and the prediction amount derived by the prediction unit 204a. Thereby, again, a possibility that a target vehicle passes through the target point P where an increase in an emission amount is expected can be decreased. Moreover, a traffic volume at the target point P where an increase in an emission amount is expected decreases, whereby a velocity change amount of the vehicle C passing through the target point P becomes smaller, and an emission amount from the vehicle C passing through the target point P can also be decreased. Thus, an increase in an emission amount from the vehicle C at the target point P where an increase in an emission amount is expected can be previously prevented. Therefore, it becomes possible to reduce an emission amount from the vehicle C at the target point P.

### Fifth Modified Example

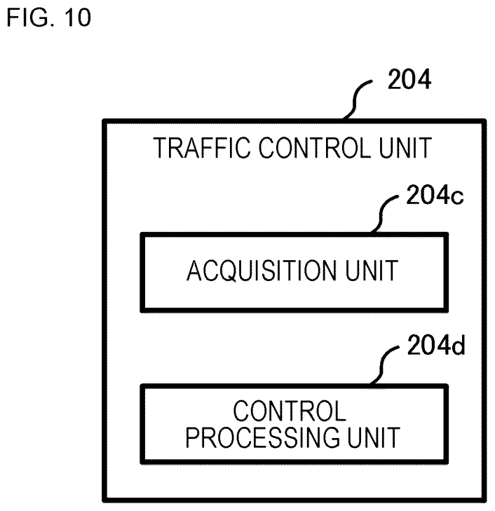

A traffic control unit 204 may control traffic of the target vehicle by use of an estimated emission amount and information relating to an CO₂ absorber provided around a target point P. The CO₂ absorber is a plant such as a tree, a coating and a member having a function of absorbing CO₂, or the like, and such a coating and a member are provided, for example, on a wall surface of a building. Information relating to a CO₂ absorber includes at least one of, for example, a position where a CO₂ absorber is installed, the number of CO₂ absorbers to be installed and an area thereof, a value indicating an ability of an installed CO₂ absorber to absorb CO₂, and the like. The traffic control unit 204 according to a fifth modified example includes an acquisition unit 204c and a control processing unit 204d, as illustrated in FIG. 10.

The acquisition unit 204c acquires absorber information. The absorber information is information relating to the CO₂ absorber described above. Absorber information may be acquired from a non-illustrated external apparatus, or may be input by a user.

The control processing unit 204d performs route guidance for a vehicle C by use of an emission amount estimated by an estimation unit 103 and absorber information acquired by the acquisition unit 204c. That is to say, a route to a destination of the vehicle C is determined by use of the estimated emission amount and the absorber information, and route information including the route is generated and transmitted to an in-vehicle apparatus E of the vehicle C.

At the target point P where many CO₂ absorbers are installed, more emission is absorbed than at the target point P where there are few CO₂ absorbers, and, therefore, an emission amount from the vehicle C in atmosphere is difficult to increase. Thus, for example, a criterion value of an emission amount is caused to be higher at the target point P where many CO₂ absorbers are installed than at the target point P where there are few CO₂ absorbers in such a way that an increase in an emission amount from the vehicle C at the target point P can be previously prevented by guiding the vehicle C to the target point P where there are many CO₂ absorbers. Therefore, it becomes possible to reduce an emission amount from the vehicle C at the target point P.

Note that, the control processing unit 204d may control a traffic light S by use of the emission amount estimated by the estimation unit 103 and the absorber information acquired by the acquisition unit 204c. Thereby, again, for example, a criterion value of an emission amount is caused to be higher at the target point P where many CO₂ absorbers are installed than at the target point P where there are few CO₂ absorbers in such a way that an increase in an emission amount from the vehicle C at the target point P can be previously prevented by guiding the vehicle C to the target point P where there are many CO₂ absorbers. Therefore, it becomes possible to reduce an emission amount from the vehicle C at the target point P.

### Sixth Modified Example

Vehicle information may include a condition relating to an emission amount. The condition is a desire of a driver relating to suppression of an emission amount, and for example, a degree of suppression of an emission amount is selected by a driver of a target vehicle from large, medium, small, and the like. A traffic control unit 204 may further refer to the condition, and determine a route to a destination of a target vehicle.

For example, the traffic control unit 204 changes, depending on a condition, a criterion value to be applied to a target vehicle. More specifically, for example, a criterion value to be applied to a target vehicle is caused to be smaller when a degree of suppression of an emission amount is set to “large” than when set to “small”. Thereby, a driver who wishes to enlarge a degree of suppression of an emission amount passes through more target points P where an emission amount is estimated to be smaller than a driver who wishes for a small degree. Thereby, it becomes possible to reduce an emission amount from the target vehicle at the target point P while considering a wish of a user.

### Seventh Modified Example

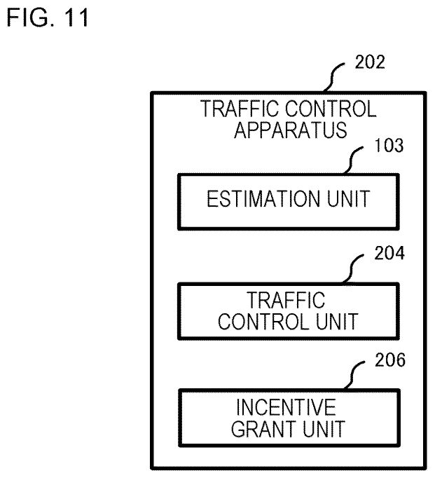

In order to motivate a driver to travel according to route guidance, a traffic control apparatus 202 may further include an incentive grant unit 206, as illustrated in FIG. 11.

When a previously determined kind of a vehicle actually travels according to route guidance, the incentive grant unit 206 grants a benefit to the vehicle. A benefit is, for example, a discount on an expressway toll, a discount on a gasoline charge, or the like.

Thereby, an incentive for setting a condition in which a user can suppress an emission amount can be granted, and a further reduction of an emission amount from a target vehicle at the target point P can be made. Therefore, it becomes possible to reduce an emission amount from the vehicle C at the target point P.

### Eighth Modified Example

A traffic control unit 204 may determine different routes even for target vehicles having a common destination, according to vehicle types of the target vehicles.

For example, the traffic control unit 204 may generate route information including a shortest route regarding a first kind of a target vehicle. Regarding a second kind of a target vehicle, route information including a route determined in such a way as to pass through a target point P where an estimated emission amount is smaller than the another target point P may be generated.

A kind of a vehicle according to the present modified example is another example of a kind relating to environmental performance of the vehicle, and is a kind relating to an emission amount of the vehicle. Specifically, the first kind is a kind of a vehicle C being smaller in an emission amount than a second kind of the vehicle C. The first type of the vehicle C is, for example, an electric vehicle, a hybrid car, or the vehicle C equipped with a CO₂ absorber. The second kind of the vehicle C is, for example, an engine vehicle.

The vehicle C equipped with a CO₂ absorber is, for example, the vehicle C with a painting having a function of absorbing CO₂, or the vehicle C in which a member having a function of absorbing CO₂ is provided on an outer surface or the like. Whether the vehicle C is a vehicle raipu equipped with a CO₂ absorber may be included in vehicle information, or may be determined based on a vehicle kind.

Thereby, when the first type of the vehicle C having a relatively smaller emission amount is a target vehicle, guidance is performed with a shortest route, and, therefore, an incentive of riding in the first kind of the vehicle C can be given. Therefore, it becomes possible to reduce an emission amount from the vehicle C at the target point P.

Moreover, for example, the traffic control unit 204 may generate, regarding the first type of a target vehicle, route information including a route determined in such a way as to pass through the target point P where an estimated emission amount is smaller. Route information including a shortest route may be generated regarding the second kind of the target vehicle.

Thereby, when the first type of the vehicle C having a relatively smaller emission amount is the target vehicle, detour of the target vehicle decreases, and, therefore, an emission amount of the whole vehicle C can be decreased. Therefore, it becomes possible to reduce an emission amount from the vehicle C at the target point P.

In this case, a traffic control apparatus 202 may include an incentive grant unit 206 described in the seventh modified example. Thereby, an incentive of traveling a route determined in such a way as to pass through the target point P with a smaller estimated emission amount among a plurality of the target points P can be given, and a further reduction of an emission amount can be made in the whole vehicle C. Therefore, it becomes possible to reduce an emission amount from the vehicle C at the target point P.

### Ninth Modified Example

A traffic control unit 204 may determine different routes even for target vehicles having a common destination, according to whether the target vehicle is a vehicle type equipped with a CO₂ absorber.

Regarding the vehicle C being a vehicle type equipped with a CO₂ absorber, the traffic control unit 204 according to the present modified example determines a route to a destination in such a way as to pass through the target point P with a large estimated emission amount among a plurality of the target points P, generates route information including the determined route, and transmits the route information to an in-vehicle apparatus E of the vehicle C.

The vehicle C equipped with the CO₂ absorber passes through the target point P with a large emission amount, and, thereby, reduction in an amount of CO₂ at the target point P can be made. Therefore, it becomes possible to reduce an emission amount from the vehicle C at the target point P.

In this case, the traffic control apparatus 202 may include an incentive grant unit 206 described in the seventh modified example. Thereby, an incentive of traveling a route determined in such a way as to pass through the target point P with a large estimated emission amount among a plurality of the target points P can be given, and a further reduction in an amount of CO₂ at the target point P can be made. Therefore, it becomes possible to reduce an emission amount from the vehicle C at the target point P.

The example embodiments and the modified examples of the present invention have been described above with reference to the drawings, but are exemplifications of the present invention, and various configurations other than those described above can also be adopted.

Moreover, although a plurality of processes (pieces of processing) are described in order in a plurality of flowcharts used in the above description, an execution order of processes executed in each example embodiment is not limited to the described order. In each example embodiment, an order of illustrated processes can be changed to an extent that causes no problem in terms of content. Moreover, each of the example embodiments and the modified examples described above can be combined to an extent that content does not contradict.

Some or all of the above-described example embodiments can also be described as, but are not limited to, the following supplementary notes.
1. A traffic control apparatus including:
   an estimation unit that estimates an emission amount of a vehicle at a target point; and
   a traffic control unit that executes processing for controlling traffic of a target vehicle by use of the estimated emission amount.
2. The traffic control apparatus according to supplementary note 1, wherein the traffic control unit controls traffic of the target vehicle by at least one of controlling one or a plurality of traffic lights and performing route guidance for the target vehicle by use of the estimated emission amount.
3. The traffic control apparatus according to supplementary note 2, further including
   an incentive grant unit that grants a benefit to the target vehicle when traveling according to the route guidance, in a case where traffic of the target vehicle is controlled by performing the route guidance.
4. The traffic control apparatus according to any one of supplementary notes 1 to 3, wherein
   the traffic control unit controls traffic of the target vehicle by use of the estimated emission amount in such a way that a velocity change amount of the target vehicle becomes small.
5. The traffic control apparatus according to any one of supplementary notes 1 to 4, wherein
   the traffic control unit controls traffic of the target vehicle in such a way as to decrease a traffic volume at the target point when the estimated emission amount exceeds a previously determined criterion value.
6. The traffic control apparatus according to any one of supplementary notes 1 to 5, wherein
   there are a plurality of the target points, and
   the traffic control unit controls traffic of the target vehicle in such a way as to pass through a target point where the estimated emission amount is small, with priority over another target point.
7. The traffic control apparatus according to supplementary note 6, wherein
   the traffic control unit controls traffic of the target vehicle in such a way as to pass through a target point where the estimated emission amount is smaller than a criterion value, with priority over another target point.
8. The traffic control apparatus according to any one of supplementary notes 2 to 7, wherein,
   when controlling traffic of a target vehicle by performing the route guidance, the traffic control unit performs route guidance for the target vehicle by use of the estimated emission amount and a kind of the target vehicle.
9. The traffic control apparatus according to supplementary note 7, wherein,
   when the target vehicle is a previously determined first kind of a vehicle, the traffic control unit performs route guidance in such a way as to pass through a target point where the estimated emission amount is large.
10. The traffic control apparatus according to supplementary note 7 or 8, wherein,
   when the target vehicle is a previously determined second kind of a vehicle, the traffic control unit performs route guidance in such a way as to pass through a target point where the estimated emission amount is small.
11. The traffic control apparatus according to any one of supplementary notes 1 to 10, wherein
   the traffic control unit includes
   a prediction unit that derives a prediction amount of an emission amount from the vehicle, and
   a control processing unit that executes processing for controlling traffic of the target vehicle at the target point by use of the estimated emission amount and the prediction amount.
12. The traffic control apparatus according to any one of supplementary notes 1 to 10, wherein
   the traffic control unit includes
   an acquisition unit that acquires information relating to a CO₂ absorber, and
   a control processing unit that performs route guidance for the vehicle by use of the estimated emission amount and information relating to the CO₂ absorber.
13. A traffic control system including:
   the traffic control apparatus according to any one of supplementary notes 1 to 12;
   a piece of sensor equipment that detects a physical amount for estimating an emission amount at the target point; and
   at least one of a traffic light and an in-vehicle apparatus.
14. A traffic control method including, by a computer:
   estimating an emission amount of a vehicle passing through a target point; and
   executing processing for controlling traffic of a target vehicle by use of the estimated emission amount.
15. A storage medium storing a program for causing a computer to execute:
   estimating an emission amount of a vehicle passing through a target point; and
   executing processing for controlling traffic of a target vehicle by use of the estimated emission amount.
16. A program for causing a computer to execute:
   estimating an emission amount of a vehicle passing through a target point; and
   executing processing for controlling traffic of a target vehicle by use of the estimated emission amount.

### REFERENCE SIGNS LIST

100, 200 Traffic control system
101, 101a to 101d Sensor equipment
102, 202 Traffic control apparatus
103 Estimation unit
104, 204 Traffic control unit
105 Storage unit

What is claimed is:

1. A traffic control apparatus comprising:
at least one memory configured to store instructions; and
at least one processor configured to execute the instructions to perform operations comprising:
estimating an emission amount of a vehicle at a target point; and
executing processing for controlling traffic of a target vehicle by use of the estimated emission amount.

2. The traffic control apparatus according to claim 1, wherein
the traffic control unit controls the processing for controlling the traffic of the target vehicle includes controlling the traffic of the target vehicle by at least one of controlling one or a plurality of traffic lights and performing route guidance for the target vehicle by use of the estimated emission amount.

3. The traffic control apparatus according to claim 2, the operations further comprising
granting a benefit to the target vehicle when traveling according to the route guidance, in a case where traffic of the target vehicle is controlled by performing the route guidance.

4. The traffic control apparatus according to claim 1, wherein
the processing for controlling the traffic of the target vehicle includes controlling the traffic of the target vehicle by use of the estimated emission amount in such a way that a velocity change amount of the target vehicle becomes small.

5. The traffic control apparatus according to claim 1, wherein
the processing for controlling the traffic of the target vehicle includes controlling the traffic of the target vehicle in such a way as to decrease a traffic volume at the target point when the estimated emission amount exceeds a previously determined criterion value.

6. The traffic control apparatus according to claim 1, wherein
there are a plurality of the target points, and
the processing for controlling the traffic of the target vehicle includes controlling the traffic of the target vehicle in such a way as to pass through a target point where the estimated emission amount is small, with priority over another target point.

7. The traffic control apparatus according to claim 6, wherein
the processing for controlling the traffic of the target vehicle includes controlling the traffic of the target vehicle in such a way as to pass through a target point where the estimated emission amount is smaller than a criterion value, with priority over another target point.

8. The traffic control apparatus according to claim 1, wherein,
the processing for controlling the traffic of the target vehicle includes performing, when controlling traffic of the target vehicle by performing the route guidance, route guidance for the target vehicle by use of the estimated emission amount and a kind of the target vehicle.

9. The traffic control apparatus according to claim 7, wherein,
the processing for controlling the traffic of the target vehicle includes performing, when the target vehicle is a previously determined first kind of a vehicle, route guidance in such a way as to pass through a target point where the estimated emission amount is large.

10. The traffic control apparatus according to claim 7, wherein,
the processing for controlling the traffic of the target vehicle includes performing, when the target vehicle is a previously determined second kind of a vehicle, the traffic control unit performs-route guidance in such a way as to pass through a target point where the estimated emission amount is small.

11. The traffic control apparatus according to claim 1, wherein
the processing for controlling the traffic of the target vehicle includes
deriving a prediction amount of an emission amount from the vehicle, and
executing processing for controlling traffic of the target vehicle at the target point by use of the estimated emission amount and the prediction amount.

12. The traffic control apparatus according to claim 1, wherein
the processing for controlling the traffic of the target vehicle includes
acquiring information relating to a CO₂ absorber, and
performing route guidance for the vehicle by use of the estimated emission amount and information relating to the CO₂ absorber.

13. A traffic control system comprising:
the traffic control apparatus according to claim 1;
a piece of sensor equipment that detects a physical amount for estimating an emission amount at the target point; and
at least one of a traffic light and an in-vehicle apparatus.

14. A traffic control method comprising,
by a computer:
estimating an emission amount of a vehicle passing through a target point; and
executing processing for controlling traffic of a target vehicle by use of the estimated emission amount.

15. A non-transitory computer readable storage medium storing a program for causing a computer to execute:
estimating an emission amount of a vehicle passing through a target point; and
executing processing for controlling traffic of a target vehicle by use of the estimated emission amount.
